(19) United States
(12) Patent Application Publication
(10) Pub. No.: US 2024/0232891 A1
(43) Pub. Date: Jul. 11, 2024

(54) BLOCKCHAIN-BASED DIGITAL TRANSACTIONAL SYSTEM WITH MACHINE-LEARNING (ML)-POWERED RULE GENERATION

(71) Applicant: Bank of America Corporation, Charlotte, NC (US)

(72) Inventors: Yogi Ahuja, Warwick, PA (US); Mardochee Macxis, Concord, NC (US); Monika Kapur, Jacksonville, FL (US); Albena Fairchild, Indian Trail, NC (US); Utkarsh Raj, Charlotte, NC (US)

(21) Appl. No.: 18/094,447

(22) Filed: Jan. 9, 2023

(51) Int. Cl. G06Q 20/40; G06Q 20/38

(52) U.S. Cl. CPC G06Q 20/4016; G06Q 20/389; G06Q 20/405

(57) ABSTRACT

Systems and methods for fraud prevention in a blockchain-based digital transactional system with machine-learning (ML)-powered rule generation are provided. Methods may include creating a distributed ledger in which digital blocks may include foundational transactional parameter rules, and digital blocks may include historical transactional data. Methods may include hosting ML models on the nodes, running each ML model to generate new transactional parameter rules, and adding the new transactional parameter rule as a digital block on the distributed ledger in response to a consensus. Methods may include receiving additional transactional data, running each ML model to generate a score representing a probability that the additional transactional data is associated with fraudulent activity, and triggering an alert for an account associated with the additional transactional data in response to a consensus across the plurality of ML models that the score exceeds a predetermined threshold score.

### FIELD OF TECHNOLOGY

Aspects of the disclosure relate to digital systems. Specifically, aspects of the disclosure relate to blockchain-based digital transactional systems with machine-learning (ML)-powered rule generation.

### BACKGROUND OF THE DISCLOSURE

Digital transactional systems have brought significant advantages for individuals and entities conducting transactions. The digital transactional systems have made conducting transactions quicker, more convenient, and more feature-rich than before.

However, digital transactional systems have also introduced new avenues for fraudulent activity. For example, the quick and anonymous nature of digital transactional systems potentially make it easier for a fraudulent actor to execute an unauthorized transaction.

Systems exist which attempt to detect fraudulent activity in digital transactional systems. These systems typically involve hard-coded rules defining suspicious activities. Such systems may be easy to circumvent. For example, a fraudulent actor may tailor an unauthorized transaction to be outside the scope of the hard-coded rules, and thereby evade detection.

It would be desirable, therefore, to provide systems and methods with increased effectiveness for fraud prevention in digital transactional systems.

### SUMMARY OF THE DISCLOSURE

Aspects of the disclosure relate to a blockchain-based digital transactional system with machine-learning (ML)-powered rule generation. Systems may include a distributed ledger. The distributed ledger may include a plurality of digital ledgers stored on a plurality of distributed nodes. Each digital ledger may include a plurality of digital blocks that are immutably and cryptographically connected to each other in sequence. Each digital block may be added to the plurality of digital ledgers based on a consensus across the nodes.

One or more of the digital blocks may include a set of foundational transactional parameter rules. Each transactional parameter rule may define transactional parameters that are associated with a likelihood of fraudulent activity. One or more of the digital blocks may include historical transactional data.

Systems may include a plurality of ML models. Each ML model may be hosted on a different one of the plurality of nodes.

Systems may be configured to run each ML model, using the foundational transactional parameter rules and the historical transactional data as inputs, to generate new transactional parameter rules.

Systems may be configured to add, in response to a consensus across the plurality of ML models to include a new transactional parameter rule, the new transactional parameter rule as a digital block on the distributed ledger.

Systems may be configured to receive additional transactional data, and run each ML model, using the foundational transactional parameter rules, the new transactional parameter rule, the historical transactional data, and the additional transactional data as inputs, to generate a score representing a probability that the additional transactional data is associated with fraudulent activity. In response to a consensus across the plurality of ML models that the score exceeds a predetermined threshold score, systems may be configured to trigger an alert for an account associated with the additional transactional data.

### BRIEF DESCRIPTION OF THE DRAWINGS

The objects and advantages of the disclosure will be apparent upon consideration of the following detailed description, taken in conjunction with the accompanying drawings, in which like reference characters refer to like parts throughout, and in which:

FIG. 1 shows an illustrative system in accordance with principles of the disclosure;

FIG. 2 shows an illustrative apparatus in accordance with principles of the disclosure;

FIG. 3 shows an illustrative diagram in accordance with principles of the disclosure;

FIG. 4 shows another illustrative diagram in accordance with principles of the disclosure; and

FIG. 5 shows an illustrative flowchart in accordance with principles of the disclosure.

### DETAILED DESCRIPTION OF THE DISCLOSURE

A blockchain-based digital transactional system with machine-learning (ML)-powered rule generation for fraud prevention is provided. Methods for fraud prevention are also provided. The methods may be implemented in the context of the system. System components, features, and configurations may correspond to steps of the methods.

Systems may include a distributed ledger. The distributed ledger may include a plurality of digital ledgers. A digital ledger may be a database. The digital ledgers may be coordinated. Coordination of the digital ledgers may include only storing information on each ledger when that information is to be stored on all the ledgers.

The digital ledgers may be stored on a plurality of distributed nodes. A node may be a computer system. The plurality of distributed nodes may include a plurality of computer systems that may be located remotely from each other. In some embodiments, the plurality of distributed nodes may include computer systems hosted by entities that are independent of each other. In some embodiments, each node may be hosted by a different financial entity. Each financial entity may have access to, and/or may facilitate, digital transactions.

Each digital ledger may include a plurality of digital blocks. The digital blocks may be connected to each other in sequence. The digital blocks may be immutably connected to each other. The digital blocks may be cryptographically connected to each other. Immutability may include the attribute that any one node may be unable to change information in a block. A node may also be unable to change the order of the blocks. The cryptographic connection may include an encrypted pointer between the blocks. The pointer may be based at least in part on information stored in the previous block. Each digital block may be added to the plurality of digital ledgers based on a consensus across the nodes.

The distributed ledger may be part of a blockchain. Generally, a distributed ledger may include a plurality of coordinated databases. Coordinating the databases may, for example, include syncing the databases based on a consensus. Each coordinated database may be stored on a distinct node from a plurality of nodes. Each coordinated database may include linked blocks of hashed data. A block that is linked to a previous block may include a hashing of the hashed data of the previous block. In certain embodiments, the data may be encrypted. In other embodiments, the data may not be hashed or encrypted. The link between the blocks may include a pointer.

Each one of the databases of the distributed ledger may be stored on a distinct one of a plurality of nodes. When the distributed ledger is initialized or updated, a data block containing data associated with the initialization/update may be created on each of the nodes. The data block may be linked to the most recent pre-update data block.

A distributed ledger may be part of a blockchain. A blockchain may be a distributed database of records or public ledger of all transactions or digital events that have been executed and shared among participants. Each transaction or digital event in the public ledger is verified by a majority of participants included in the system. Once a transaction or digital event is executed, it can never be erased. The blockchain therefore contains an immutable and verifiable record of each transaction or event. An encrypted blockchain also provides a secure and anonymous architecture for storing sensitive information.

A distributed electronic ledger may store records in any suitable format. For example, records may be stored sequentially as they are generated, one after the other in a continuous ledger. Records may be stored in blocks, such as in a blockchain.

Records stored in a distributed electronic ledger may only be added to the ledger when the participants responsible for maintaining the distributed ledger (e.g., participant devices or nodes) reach a consensus. The distributed ledger may use any suitable consensus algorithm such as Proof of Work, Proof of Stake or Practical Byzantine Fault Tolerance.

The distributed ledger may be a public or unpermissioned distributed ledger. A public distributed ledger does not have restrictions on who may participate in establishing a consensus for adding a new record.

The distributed ledger may be a private or permissioned distributed ledger. A private distributed ledger has restrictions on who may participate in establishing a consensus for adding a new record.

The distributed ledger may utilize a combination of private and public participation in establishing a consensus. For example, the distributed ledger may require a threshold number of private and/or public votes before recording a transaction on the distributed ledger. Utilization of private entities may allow for achieving a consensus (or rejection) of a transaction faster than wholly public distributed ledgers.

The distributed ledger may include a blockchain of electronic data records. Each record may be authenticated by a consensus protocol. A complete copy of the blockchain may be stored on multiple computer systems. Each computer system that stores a copy of the blockchain may be a “node.”

Groups of authenticated transactions, or other suitable information, may be gathered into “blocks.” A node may add a “block” to the blockchain. Each block may include data and metadata. Metadata may include a reference to the previous block in the chain and a unique identifier associated with the previous block. The unique identifier may be an output of a hash function.

One or more of the digital blocks may include a set of foundational transactional parameter rules. Each transactional parameter rule may define transactional parameters that are associated with a likelihood of fraudulent activity. In some embodiments, the transactional parameters may include one or more parameters from a list that includes transaction size, transaction amount, transaction volume, transaction speed, transaction location, and transaction time. Each rule may define a specific pattern of one or more of the parameters. For example, one rule may define “a purchase in a foreign city exceeding $1000 between midnight and 6 AM.” Some rules may consider a sequence of transactions, for example, “10 purchases above $500 in one day.”

In some embodiments, the foundational transactional parameter rules may be received from an agency that is independent of the system. The agency may, in one illustrative example, be the United States Federal Reserve. The agency may be any suitable public or private sector entity that may promulgate transactional parameter rules. In some embodiments, the foundational transactional parameter rules may include at least 150 rules.

One or more of the digital blocks may include historical transactional data. The historical transactional data may include records of actual transactions executed by accounts associated with the system. The accounts may be associated with entities hosting the nodes. Each node may, in some embodiments, be hosted by a different financial entity. Each entity may contribute transactional data native to, or generated from, that entity. In some embodiments, the transactional data may also include artificial features that may be integrated into the data for the purpose of training the ML models. In some embodiments, the transactional data may include cryptocurrency transactions.

In some embodiments, each financial entity and each account associated with data stored on the ledger may have opted into the system. The opt in may be advantageous because, even though blockchains are typically associated with a high level of anonymity, some of the anonymity in the disclosed system may be stripped away to expose information useful for fraud detection. For example, the blockchain may expose transactional data of one node/entity to another node/entity. Accordingly, the system may be configured so that although data is not exposed outside the blockchain, the data may be shared among the blockchain participants who opted into the system.

Systems may include a plurality of ML models. Each ML model may be hosted on a different one of the plurality of nodes.

Systems may be configured to run each ML model, using the foundational transactional parameter rules and the historical transactional data as inputs, to generate new transactional parameter rules. The new rules may take into account more contextual information than is considered by the foundational rules. The new rules may also take into account information and tendencies unique to each particular account. The new rules may be an expansion of the foundational rules. The new rules may also, in some circumstances, provide exceptions to the foundational rules. For example, whereas the foundational rule may have defined “a $1000 purchase in a foreign city” as a suspicious pattern, the new rule may expand that to a lower amount when part of a larger pattern of suspicious activity. Conversely, the new rules may define an exception to the foundational rule of “a $1000 purchase in a foreign city” when in a larger context that mitigates suspicion—for example, if the account recently purchased airfare to the foreign city, the account recently purchased a “Happy Birthday” card, and the $1000 purchase is for an item that may be a birthday gift.

The new rules may therefore provide a more nuanced, tailored, approach that increases accuracy while decreasing false positives as well as false negatives.

Systems may be configured to add, in response to a consensus across the plurality of ML models to include a new transactional parameter rule, the new transactional parameter rule as a digital block on the distributed ledger.

Systems may be configured to receive additional transactional data. The additional transactional data may be a transaction or a set of transactions. The system may be configured to run each ML model, using the foundational transactional parameter rules, the new transactional parameter rule, the historical transactional data, and the additional transactional data as inputs, to generate a score representing a probability that the additional transactional data is associated with fraudulent activity. In response to a consensus across the plurality of ML models that the score exceeds a predetermined threshold score, systems may be configured to trigger an alert for an account associated with the additional transactional data.

In some embodiments, the system may be further configured to run each ML model, using the foundational transactional parameter rules, the new transactional parameter rule, the historical transactional data, and the additional transactional data as inputs, to generate additional new transactional parameter rules. The system may also be configured to add, in response to a consensus across the plurality of ML models to include an additional new transactional parameter rule, the additional new transactional parameter rule as a digital block on the distributed ledger.

In some embodiments, the system may be configured to store the ML models as digital blocks on the distributed ledger. Storing the ML models on the ledger may include storing the software of the ML models on the ledger. Storing the ML models on the ledger may sync the ML models across the system. Syncing the ML models may still potentially allow for different outputs, such as probability scores or new rules, at runtime. The system may therefore still benefit from a consensus-based approach for accepting the outputs.

In some embodiments, the system may be further configured to update each ML model based on a consensus across the ML models. The updates may be the result of additional training to the ML models. The updated models may be stored as new blocks on the blockchain instead of direct updates to the original models. This may be due to the immutable nature of the blockchain.

Apparatus and methods described herein are illustrative. Apparatus and methods in accordance with this disclosure will now be described in connection with the figures, which form a part hereof. The figures show illustrative features of apparatus and method steps in accordance with the principles of this disclosure. It is understood that other embodiments may be utilized, and that structural, functional, and procedural modifications may be made without departing from the scope and spirit of the present disclosure.

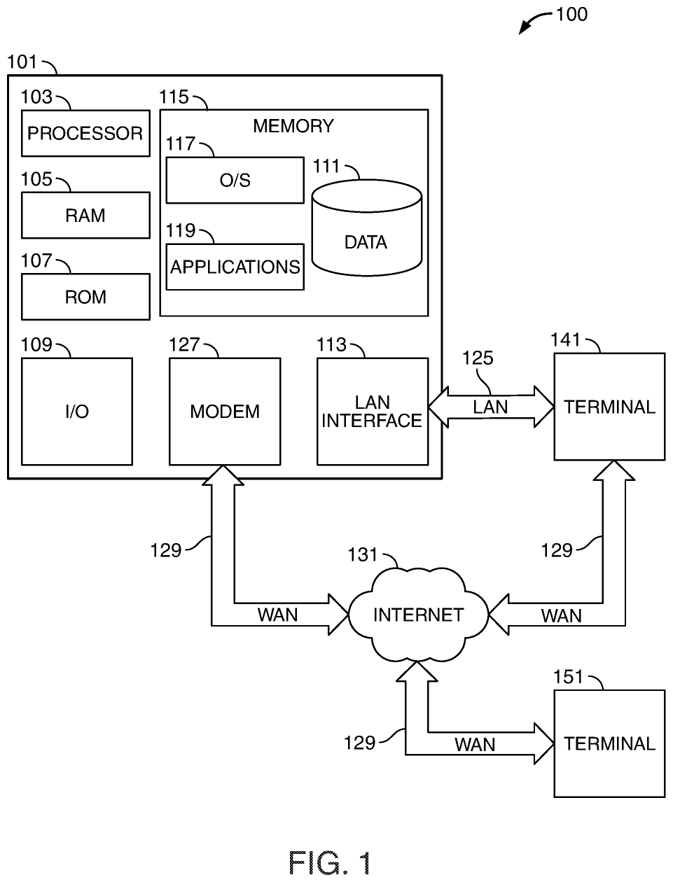

FIG. 1 shows an illustrative block diagram of system 100 that includes computer 101. Computer 101 may alternatively be referred to herein as a “server” or a “computing device.” Computer 101 may be a workstation, desktop, laptop, tablet, smart phone, or any other suitable computing device. Elements of system 100, including computer 101, may be used to implement various aspects of the systems and methods disclosed herein.

Computer 101 may have a processor 103 for controlling the operation of the device and its associated components, and may include RAM 105, ROM 107, input/output module 109, and a memory 115. The processor 103 may also execute all software running on the computer—e.g., the operating system and/or voice recognition software. Other components commonly used for computers, such as EEPROM or Flash memory or any other suitable components, may also be part of the computer 101.

The memory 115 may comprise any suitable permanent storage technology—e.g., a hard drive. The memory 115 may store software including the operating system 117 and application(s) 119 along with any data 111 needed for the operation of the system 100. Memory 115 may also store videos, text, and/or audio assistance files. The videos, text, and/or audio assistance files may also be stored in cache memory, or any other suitable memory. Alternatively, some or all of computer executable instructions (alternatively referred to as “code”) may be embodied in hardware or firmware (not shown). The computer 101 may execute the instructions embodied by the software to perform various functions.

Input/output (“I/O”) module may include connectivity to a microphone, keyboard, touch screen, mouse, and/or stylus through which a user of computer 101 may provide input. The input may include input relating to cursor movement. The input may relate to executing and/or tracking digital transactions. The input/output module may also include one or more speakers for providing audio output and a video display device for providing textual, audio, audiovisual, and/or graphical output. The input and output may be related to computer application functionality. The input and output may be related to executing and/or tracking digital transactions.

System 100 may be connected to other systems via a local area network (LAN) interface 113.

System 100 may operate in a networked environment supporting connections to one or more remote computers, such as terminals 141 and 151. Terminals 141 and 151 may be personal computers or servers that include many or all of the elements described above relative to system 100. The network connections depicted in FIG. 1 include a local area network (LAN) 125 and a wide area network (WAN) 129, but may also include other networks. When used in a LAN networking environment, computer 101 is connected to LAN 125 through a LAN interface or adapter 113. When used in a WAN networking environment, computer 101 may include a modem 127 or other means for establishing communications over WAN 129, such as Internet 131.

It will be appreciated that the network connections shown are illustrative and other means of establishing a communications link between computers may be used. The existence of various well-known protocols such as TCP/IP, Ethernet, FTP, HTTP and the like is presumed, and the system can be operated in a client-server configuration to permit a user to retrieve web pages from a web-based server. The web-based server may transmit data to any other suitable computer system. The web-based server may also send computer-readable instructions, together with the data, to any suitable computer system. The computer-readable instructions may be to store the data in cache memory, the hard drive, secondary memory, or any other suitable memory.

Additionally, application program(s) 119, which may be used by computer 101, may include computer executable instructions for invoking user functionality related to communication, such as e-mail, Short Message Service (SMS), and voice input and speech recognition applications. Application program(s) 119 (which may be alternatively referred to herein as “plugins,” “applications,” or “apps”) may include computer executable instructions for invoking user functionality related to performing various tasks. The various tasks may be related to executing and/or tracking digital transactions.

Computer 101 and/or terminals 141 and 151 may also be devices including various other components, such as a battery, speaker, and/or antennas (not shown).

Terminal 151 and/or terminal 141 may be portable devices such as a laptop, cell phone, Blackberry™, tablet, smartphone, or any other suitable device for receiving, storing, transmitting and/or displaying relevant information. Terminals 151 and/or terminal 141 may be other devices. These devices may be identical to system 100 or different. The differences may be related to hardware components and/or software components.

Any information described above in connection with database 111, and any other suitable information, may be stored in memory 115. One or more of applications 119 may include one or more algorithms that may be used to implement features of the disclosure, and/or any other suitable tasks.

The invention may be operational with numerous other general purpose or special purpose computing system environments or configurations. Examples of well-known computing systems, environments, and/or configurations that may be suitable for use with the invention include, but are not limited to, personal computers, server computers, hand-held or laptop devices, tablets, mobile phones, smart phones and/or other personal digital assistants (“PDAs”), multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc., that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

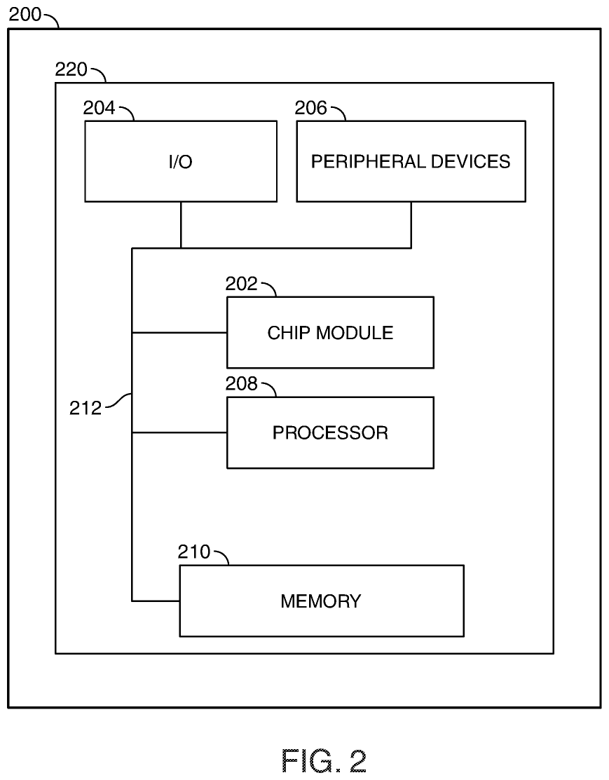

FIG. 2 shows illustrative apparatus 200 that may be configured in accordance with the principles of the disclosure. Apparatus 200 may be a computing machine. Apparatus 200 may include one or more features of the apparatus shown in FIG. 1. Apparatus 200 may include chip module 202, which may include one or more integrated circuits, and which may include logic configured to perform any other suitable logical operations.

Apparatus 200 may include one or more of the following components: I/O circuitry 204, which may include a transmitter device and a receiver device and may interface with fiber optic cable, coaxial cable, telephone lines, wireless devices, PHY layer hardware, a keypad/display control device or any other suitable media or devices; peripheral devices 206, which may include counter timers, real-time timers, power-on reset generators or any other suitable peripheral devices; logical processing device 208, which may compute data structural information and structural parameters of the data; and machine-readable memory 210.

Machine-readable memory 210 may be configured to store in machine-readable data structures: machine executable instructions (which may be alternatively referred to herein as “computer instructions” or “computer code”), applications, signals, and/or any other suitable information or data structures.

Components 202, 204, 206, 208 and 210 may be coupled together by a system bus or other interconnections 212 and may be present on one or more circuit boards such as 220. In some embodiments, the components may be integrated into a single chip. The chip may be silicon-based.

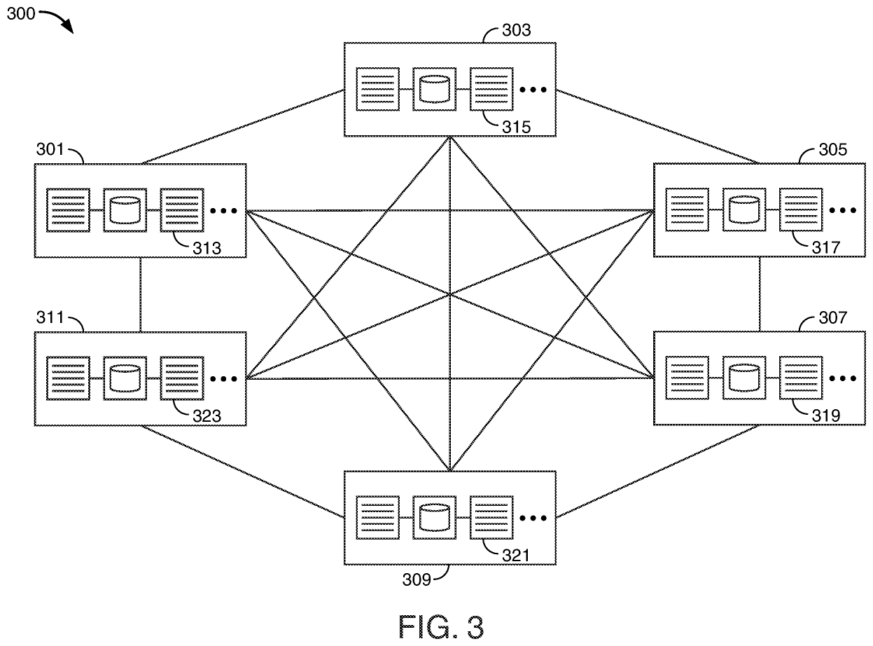

FIG. 3 shows illustrative diagram 300 in accordance with principles of the disclosure. Diagram 300 shows illustrative aspects of a blockchain-based digital transactional systems with machine-learning (ML)-powered rule generation. The system may include nodes 301-311. Each of nodes 301-311 may be a computer system hosted by a separate entity. The nodes are shown interconnected with each other to signify that the each node may be in digital communication with all the other nodes. Each of nodes 301-311 may store a copy of a coordinated, distributed, ledger. The copies of the coordinated, distributed, ledger are shown in diagram 300 as ledgers 313-323.

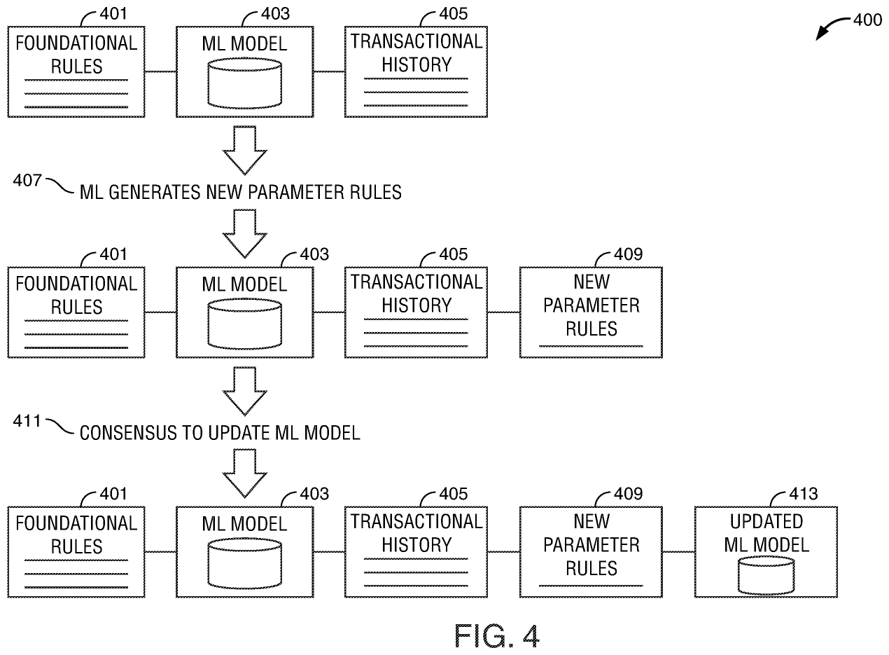

FIG. 4 shows illustrative diagram 400 in accordance with principles of the disclosure. Diagram 400 shows illustrative aspects of a blockchain-based digital transactional systems with machine-learning (ML)-powered rule generation.

Diagram 400 shows an illustrative digital ledger that may be part of a distributed ledger according to aspects of the disclosure. The ledger may include blocks 401, 403, and 405. Block 401 may store foundational rules. Block 403 may store an ML model. Block 405 may store historical transactional data.

At 407 the ML models may generate new parameter rules. In response to satisfying a consensus for the new parameter rule, the new parameter rule may be appended as new block 409 to the ledger.

At 411 the system may generate an update for the ML model. In response to satisfying a consensus for the update, an updated version of the ML model stored in block 403 may be appended as new block 413 to the ledger. The system may not be able to directly update the ML model stored in block 403 due to the immutable nature of a blockchain. Accordingly, the system may opt to store a new, updated, version of the ML model in a new block to reflect the agreed-upon update.

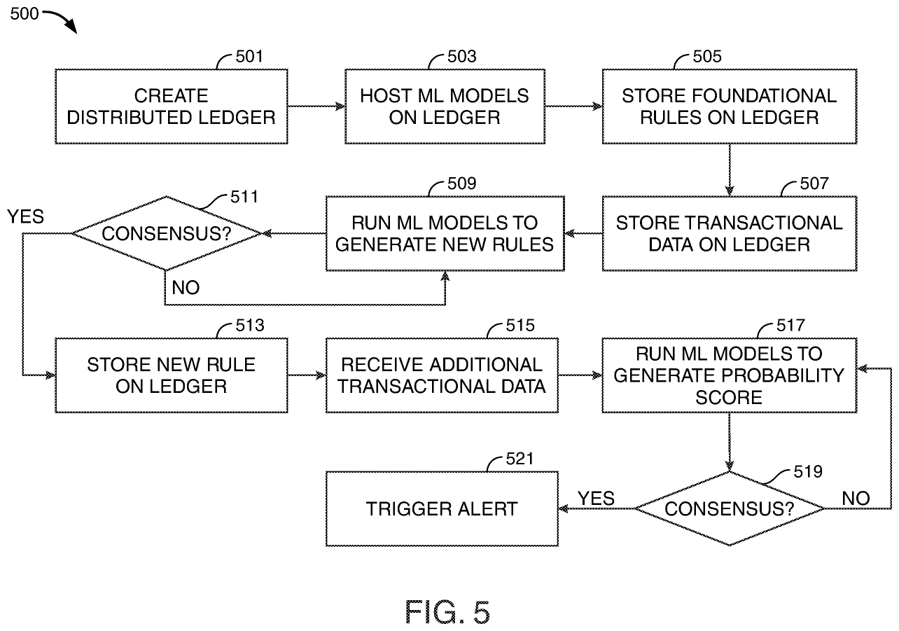

FIG. 5 shows illustrative flowchart 500 in accordance with principles of the disclosure. Flowchart 501 shows process steps for an exemplary method for fraud prevention in a blockchain-based digital transactional systems with machine-learning (ML)-powered rule generation.

The method includes creating a distributed ledger at step 501. The method includes hosting ML models on the ledger at step 503. The method includes storing foundational rules on the ledger at step 505. The method includes storing transactional data on the ledger at step 507.

At step 509, the method includes running the ML models to generate new parameter rules. At step 511 the distributed ledger determines if a consensus is satisfied for adding the new rule. If a consensus is not satisfied, the method may revert to step 509. If a consensus is reached, the method may proceed to step 513, and store the new rule as a new block on the ledger.

At step 515 the system may receive additional transactional data. At step 517 the method includes running the ML models to generate a score representing the probability of a fraudulent transaction. At step 519 the distributed ledger determines if a consensus is satisfied for the probability score a predetermined safety threshold. If a consensus is not satisfied, the method may revert to step 517. If a consensus is reached, the method may proceed to step 521, and trigger an alert regarding an account associated with the additional transactional data.

The steps of methods may be performed in an order other than the order shown and/or described herein. Embodiments may omit steps shown and/or described in connection with illustrative methods. Embodiments may include steps that are neither shown nor described in connection with illustrative methods.

Illustrative method steps may be combined. For example, an illustrative method may include steps shown in connection with another illustrative method.

Apparatus may omit features shown and/or described in connection with illustrative apparatus. Embodiments may include features that are neither shown nor described in connection with the illustrative apparatus. Features of illustrative apparatus may be combined. For example, an illustrative embodiment may include features shown in connection with another illustrative embodiment.

The drawings show illustrative features of apparatus and methods in accordance with the principles of the invention. The features are illustrated in the context of selected embodiments. It will be understood that features shown in connection with one of the embodiments may be practiced in accordance with the principles of the invention along with features shown in connection with another of the embodiments.

One of ordinary skill in the art will appreciate that the steps shown and described herein may be performed in other than the recited order and that one or more steps illustrated may be optional. The methods of the above-referenced embodiments may involve the use of any suitable elements, steps, computer-executable instructions, or computer-readable data structures. In this regard, other embodiments are disclosed herein as well that can be partially or wholly implemented on a computer-readable medium, for example, by storing computer-executable instructions or modules or by utilizing computer-readable data structures.

Thus, methods and systems for blockchain-based digital transactional systems with machine-learning (ML)-powered rule generation are provided. Persons skilled in the art will appreciate that the present invention can be practiced by other than the described embodiments, which are presented for purposes of illustration rather than of limitation, and that the present invention is limited only by the claims that follow.

What is claimed is:

1. A blockchain-based digital transactional system with machine-learning (ML)-powered rule generation, the system comprising:
a distributed ledger, the distributed ledger comprising a plurality of coordinated digital ledgers stored on a plurality of distributed nodes, wherein:
each digital ledger comprises a plurality of digital blocks that are immutably and cryptographically connected to each other in sequence;
each digital block is added to the plurality of digital ledgers based on a consensus across the nodes;
one or more of the digital blocks comprises a set of foundational transactional parameter rules, each transactional parameter rule defining transactional parameters that are associated with a likelihood of fraudulent activity; and
one or more of the digital blocks comprises historical transactional data; and
a plurality of ML models, wherein each ML model is hosted on a different one of the plurality of nodes;
wherein the system is configured to:
run each ML model, using the foundational transactional parameter rules and the historical transactional data as inputs, to generate new transactional parameter rules;
add, in response to a consensus across the plurality of ML models to include a new transactional parameter rule, the new transactional parameter rule as a digital block on the distributed ledger;
receive additional transactional data;
run each ML model, using the foundational transactional parameter rules, the new transactional parameter rule, the historical transactional data, and the additional transactional data as inputs, to generate a score representing a probability that the additional transactional data is associated with fraudulent activity; and
in response to a consensus across the plurality of ML models that the score exceeds a predetermined threshold score, trigger an alert for an account associated with the additional transactional data.

2. The system of claim 1 further configured to:
run each ML model, using the foundational transactional parameter rules, the new transactional parameter rule, the historical transactional data, and the additional transactional data as inputs, to generate additional new transactional parameter rules; and
add, in response to a consensus across the plurality of ML models to include an additional new transactional parameter rule, the additional new transactional parameter rule as a digital block on the distributed ledger.

3. The system of claim 1 wherein the transactional data comprises cryptocurrency transactions.

4. The system of claim 1 further configured to store the ML models as digital blocks on the distributed ledger.

5. The system of claim 4 further configured to update each ML model based on a consensus across the ML models.

6. The system of claim 1 wherein the transactional parameters comprise one or more parameters from a list comprising transaction size, transaction amount, transaction volume, transaction speed, transaction location, and transaction time.

7. The system of claim 1 wherein the foundational transactional parameter rules are received from an agency that is independent of the system.

8. The system of claim 1 wherein the foundational transactional parameter rules comprise at least 150 rules.

9. The system of claim 1 wherein each node is hosted by a different financial entity.

10. The system of claim 9 wherein each financial entity and each account associated with transactional opted into the system.

11. A method for fraud prevention in a blockchain-based digital transactional system with machine-learning (ML)-powered rule generation, the method comprising:
creating a distributed ledger, the distributed ledger comprising a plurality of coordinated digital ledgers stored on a plurality of distributed nodes, wherein:
each digital ledger comprises a plurality of digital blocks that are immutably and cryptographically connected to each other in sequence;
each digital block is added to the plurality of digital ledgers based on a consensus across the nodes;
one or more of the digital blocks comprises a set of foundational transactional parameter rules, each transactional parameter rule defining transactional parameters that are associated with a likelihood of fraudulent activity; and
one or more of the digital blocks comprises historical transactional data;
hosting a plurality of ML models on the plurality of nodes, wherein each ML model is hosted on a different one of the plurality of nodes;
running each ML model, using the foundational transactional parameter rules and the historical transactional data as inputs, to generate new transactional parameter rules;
adding, in response to a consensus across the plurality of ML models to include a new transactional parameter rule, the new transactional parameter rule as a digital block on the distributed ledger;
receiving additional transactional data;
running each ML model, using the foundational transactional parameter rules, the new transactional parameter rule, the historical transactional data, and the additional transactional data as inputs, to generate a score representing a probability that the additional transactional data is associated with fraudulent activity; and
in response to a consensus across the plurality of ML models that the score exceeds a predetermined threshold score, triggering an alert for an account associated with the additional transactional data.

12. The method of claim 11 further comprising:
running each ML model, using the foundational transactional parameter rules, the new transactional parameter rule, the historical transactional data, and the additional transactional data as inputs, to generate additional new transactional parameter rules; and
adding, in response to a consensus across the plurality of ML models to include an additional new transactional parameter rule, the additional new transactional parameter rule as a digital block on the distributed ledger.

13. The method of claim 11 wherein the transactional data comprises cryptocurrency transactions.

14. The method of claim 11 further comprising storing the ML models as digital blocks on the distributed ledger.

15. The method of claim 14 further comprising updating each ML model based on a consensus across the ML models.

16. The method of claim 11 wherein the transactional parameters comprise one or more parameters from a list comprising transaction size, transaction amount, transaction volume, transaction speed, transaction location, and transaction time.

17. The method of claim 11 further comprising receiving the foundational transactional parameter rules from an agency that is independent of the system.

18. The method of claim 11 wherein the foundational transactional parameter rules comprise at least 150 rules.

19. The method of claim 11 further comprising hosting each node by a different financial entity.

20. The method of claim 19 further comprising accepting into the system each financial entity and each account associated with transactional data in response to an opt in.
